(19) United States
(12) Patent Application Publication
(10) Pub. No.: US 2023/0281720 A1
(43) Pub. Date: Sep. 7, 2023

(54) Machine Learning Systems and Methods for Return on Investment Determinations from Sparse Data

(71) Applicant: Xactware Solutions, Inc., Lehi, UT (US)

(72) Inventors: Sihui Shao, Emeryville, CA (US); Haowei Song, San Rafael, CA (US); Dane Oborn, Pleasant Grove, UT (US); Lisa Sayegh, New York, NY (US); David Obert, Mapleton, UT (US)

(73) Assignee: Xactware Solutions, Inc., Lehi, UT (US)

(21) Appl. No.: 18/178,208

(22) Filed: Mar. 3, 2023

Related U.S. Application Data
(60) Provisional application No. 63/316,181, filed on Mar. 3, 2022.

(51) Int. Cl. G06Q 40/06; G06F 40/279

(52) U.S. Cl. CPC G06Q 40/06; G06F 40/279

(57) ABSTRACT

Machine learning systems and methods for return on investment determinations from sparse data are provided. The system identifies one or more renovation projects of one or more properties, adjusts a property price for each of the one or more properties based at least in part on a price index, determines a group of properties with similar property characteristics using one or more trained machine learning models, calculates a price difference between each of the one or more properties after renovation and a similar property without renovation of the group of properties, and calculates cost of the one or more renovation projects. The system then calculates a return on investment (ROI) associated with each of the one or more properties.

### RELATED APPLICATIONS

The present application claims the priority of U.S. Provisional Patent Application Ser. No. 63/316,181 filed on Mar. 3, 2022, the entire disclosure of which is expressly incorporated herein by reference.

### BACKGROUND

### Technical Field

The present disclosure relates generally to the field of machine learning. More specifically, the present disclosure relates to machine learning systems and methods for return on investment determinations from sparse data.

### Related Art

Property investors focus on purchasing properties (e.g., residential properties, commercial properties) for the purpose of generating investment income. For example, some property investors renovate the property and sell or rent the renovated property. However, it is often challenging to estimate a return on investment because it is difficult to accurately estimate a renovation cost and a market price of the property after renovation. Property renovation is a complex process that involves multiple operations (e.g., determining types of renovation, goods and labor to complete the renovation, renovation costs, and so forth). Manual estimation of the renovation cost can be extremely inconsistent across different properties and time-consuming, even when performed by the same individual. Further, effective tools which accurately estimate the market price of the property after renovation due to data sparsity are sorely lacking (e.g., limited geographic data associated with different renovation projects, limited properties having similar renovations in the same area, or the like).

Thus, what would be desirable are machine learning systems and methods for return on investment determinations from sparse data, which address the foregoing, and other, needs.

### SUMMARY

The present disclosure relates to machine learning systems and methods for return on investment determinations from sparse data. The system identifies one or more renovation projects (e.g., kitchen remodel, bathroom remodel, a basement finish, cleaning, etc.) of one or more properties (e.g., real estate properties). The system adjusts a property price (e.g., a market price) for each of the one or more properties based at least in part on a price index (e.g., a ratio of median prices associated with different time periods at a zip code level). The system determines a group of properties with similar property characteristics (e.g., a living area size, a lot size, a number of bathrooms, a number of bedrooms, a number of garage spaces, a listed price, property types, a built year, a ratio between a living area size and a lot size, etc.). The system calculates a price difference between each of the one or more properties after renovation and a similar property without renovation of the group of properties. The system calculates cost of the one or more renovation projects. The system calculates a return on investment (ROI) associated with each of the one or more properties. The system adjusts the ROI to avoid extreme values. During a deployment process, the system receives a property address and names of one or more renovation jobs (e.g., by a user input). The system determines a zip code level (e.g., an indicator indicative of an aggregation analytics level for a particular zip code) associated with the property address based at least in part on at least one of the property characteristics. The system determines a comparable property group based at least in part on the zip code level, and determines a job group (e.g., the renovation projects) based at least in part on the names. The system determines an ROI based at least in part on the comparable property group and the job group.

### BRIEF DESCRIPTION OF THE DRAWINGS

The foregoing features of the invention will be apparent from the following Detailed Description of the Invention, taken in connection with the accompanying drawings, in which:

FIG. 1 is a diagram illustrating an embodiment of the system of the present disclosure;

FIG. 2 is a flowchart illustrating overall processing steps carried out by the system of the present disclosure;

FIG. 3 is a diagram illustrating text processing carried out by the system;

FIG. 4 is a diagram illustrating data flows among lookup tables generated by the system;

FIG. 5 is a diagram illustrating single family examples in different comparable property groups and in the same state;

FIG. 6 is a flowchart illustrating deployment steps carried out by the system 10 of the present disclosure;

FIG. 7 is a diagram illustrating an example deployment workflow carried out by the processes of FIG. 6;

FIG. 8 is a diagram illustrating an example deployment workflow carried out by the processes of FIG. 6 and using an example property address and a renovation job name; and

FIG. 9 is a diagram illustrating hardware and software components capable of being utilized to implement the system of the present disclosure.

### DETAILED DESCRIPTION

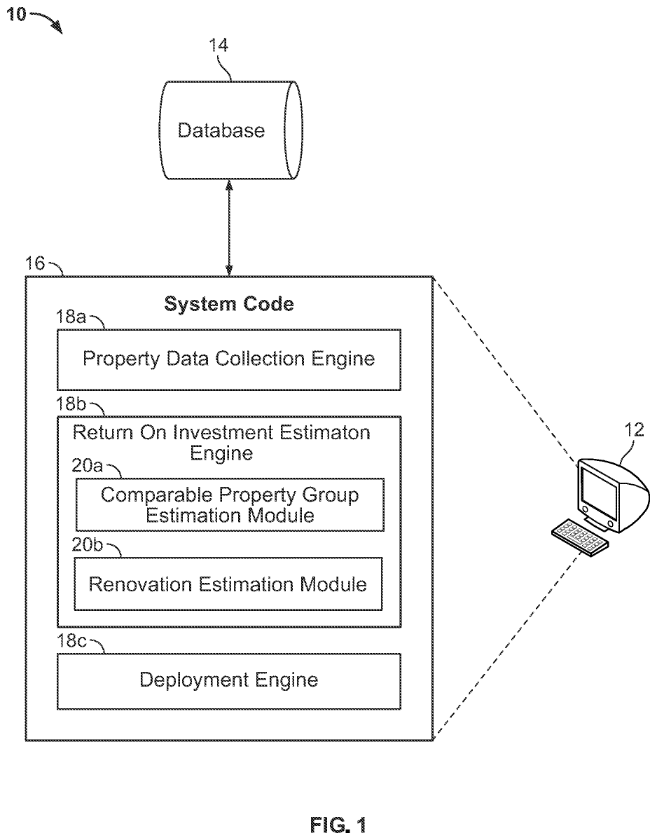

The present disclosure relates to machine learning systems and methods for return on investment determinations from sparse data, as described in detail below in connection with FIGS. 1-9.

Turning to the drawings, FIG. 1 is a diagram illustrating an embodiment of the system 10 of the present disclosure. The system 10 can be embodied as a central processing unit 12 (processor) in communication with a database 14. The processor 12 can include, but is not limited to, a computer system, a server, a personal computer, a cloud computing device, a smart phone, or any other suitable device programmed to carry out the processes disclosed herein. The system 10 can retrieve data from the database 14 associated with major residential property types (e.g., residential properties such as single family, condo/townhouse, mobile home, multi-family and other, and commercial properties such as a company site, a commercial building, a retail store, etc.).

The database 14 can include various types of data including, but not limited to, data associated with one or more properties (e.g., data associated with property characteristics, lookup tables generated by the system 10, and/or data associated with similar properties), one or more outputs from various components of the system 10 (e.g., outputs from a property data collection engine 18a, a return on investment estimation engine 18b, a comparable property group estimation module 20a, a renovation estimation module 20b, a deployment engine 18c, and/or other components of the system 10), one or more machine learning models, and associated training data. It is noted that the return on investment estimation engine 18b could comprise and/or communicate with one or more commercially available pricing databases, such as pricing databases provided by XACTWARE SOLUTIONS, INC, and/or the property data collection engine 18a could comprise and/or communicate with one or more external databases. The system 10 includes system code 16 (non-transitory, computer-readable instructions) stored on a computer-readable medium and executable by the hardware processor 12 or one or more computer systems. The system code 16 can include various custom-written software modules that carry out the steps/processes discussed herein, and can include, but is not limited to, the property data collection engine 18a, the return on investment estimation engine 18b, the comparable property group estimation module 20a, the renovation estimation module 20b, the deployment engine 18c, and/or other components of the system 10. The system code 16 can be programmed using any suitable programming languages including, but not limited to, C, C++, C #, Java, Python, or any other suitable language. Additionally, the system code 16 can be distributed across multiple computer systems in communication with each other over a communications network, and/or stored and executed on a cloud computing platform and remotely accessed by a computer system in communication with the cloud platform. The system code 16 can communicate with the database 14, which can be stored on the same computer system as the code 16, or on one or more other computer systems in communication with the code 16.

Still further, the system 10 can be embodied as a customized hardware component such as a field-programmable gate array (“FPGA”), an application-specific integrated circuit (“ASIC”), embedded system, or other customized hardware components without departing from the spirit or scope of the present disclosure. It should be understood that FIG. 1 is only one potential configuration, and the system 10 of the present disclosure can be implemented using a number of different configurations.

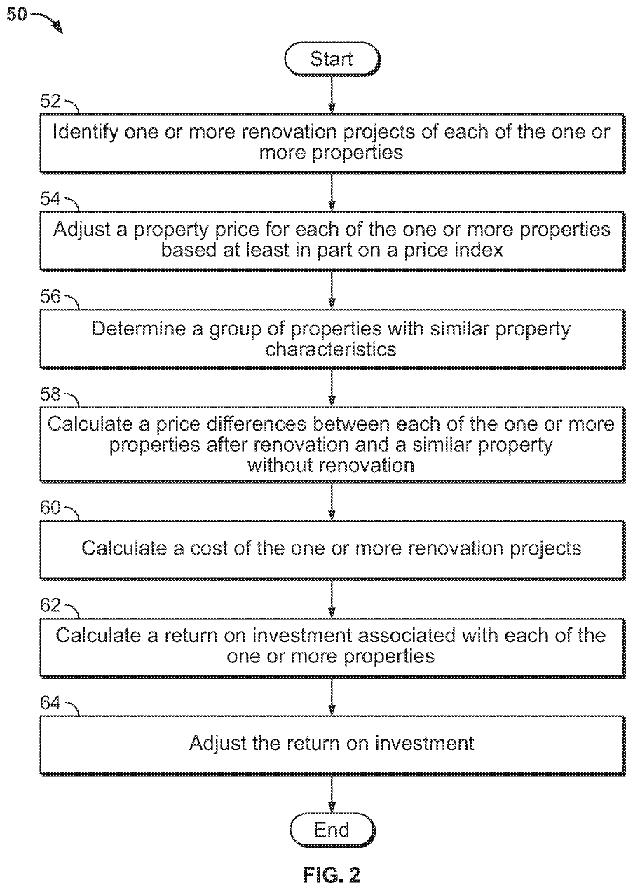

FIG. 2 is a flowchart illustrating overall processing steps 50 carried out by the system 10 of the present disclosure. Beginning in step 52, the system 10 identifies one or more renovation projects of each of the one or more properties. A property can have various types, such as single family, condo/townhouse, mobile home, multi-family and other. The system 10 can perform data processing on remarks associated with the properties (e.g., agent notes, public remarks on online marketplaces and/or listing resources, descriptions of the properties, or the like) to identity if a property is the subject of a renovation and what renovation project(s) were performed before listing of the property for sale/rent. The data processing can include data filtering and text processing of each remark. Data filtering can be based on one or more criteria (e.g., a built year threshold, keywords, and exclusion lists). The system 10 can analyze properties built in years satisfying the built year threshold (e.g., a value or a range relative to a time of listing indicative of a property to be considered). For example, if the built year threshold is set to 5 years, the system 10 can analyze properties which were built more than 5 years before the time of listing. Further, the system 10 can select a property if the property was listed in May 2019 and built year was 2015. The system 10 can extract year of listing and calculate difference between a year of built and a listed year.

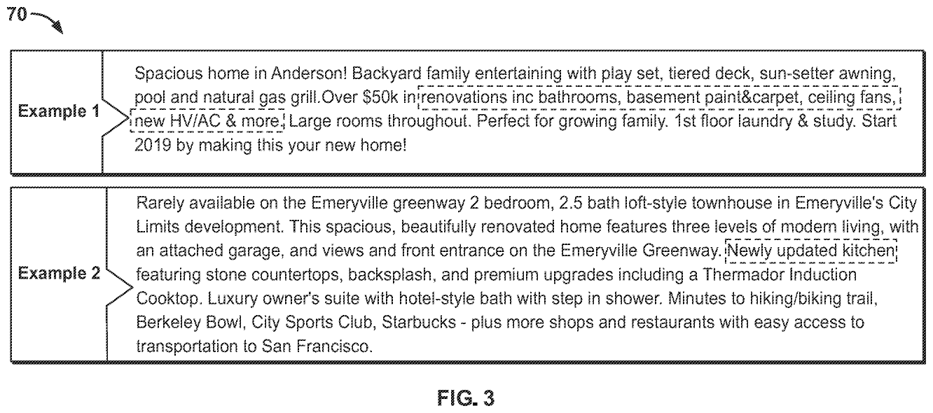

In some embodiments, the system 10 can further analyze properties based on keywords in the remarks. Examples of keywords include renovation, update, refinish, new, remodel, upgrade, refurbish, rebuild and rework, and other suitable words associated with renovations. In some embodiments, the system 10 can ignore properties having words in an exclusion list (e.g., a list having the words “new home,” “newly built,” “to be built,” “new build,” etc.). The system 10 can perform text processing on the remarks. For example, the system 10 can generate n-gram phrases (up to 4 or more grams) and frequencies. The system 10 can further map renovation content phrases satisfying a frequency threshold (e.g., more than 600 frequencies) with renovation project types and/or select out any phrase or word indicating premium quality. For example, as shown in FIG. 3 (which is a diagram illustrating an example text processing 70 carried out by the system 10), the system 10 can automatically and/or manually extract frequency phrases. Specifically, example 1 indicates a property with bathroom, basement, HV/AC renovations, and example 2 indicates a kitchen renovation in that property.

In some embodiments, to identify the renovation projects, the system 10 can perform one or more of the operations, such as locating remarks with a first group of keywords, selecting embedding sentences with keywords but not with words in an exclusion list, selecting properties built satisfying a built year threshold (e.g., built more than 5 years before the property is listed), normalizing words with lower cases, lemmatizing text of remarks, removing stop words (e.g., a set of commonly used words in a language, such as “a”, “the”, “is”, “are” and etc., or words in a stop list defined by a user or the system 10), extracting one or more phrases (e.g., noun+noun or adjective+noun), generating n-gram phrases and frequencies, and analyzing n-gram results, and mapping renovation related phrases satisfying a frequency threshold to various renovation project types.

In some embodiments, the system 10 can utilize natural language processing techniques and/or data filtering techniques to perform data processing and the above operations. By performing step 52, the system 10 can narrow down public remarks step by step using a natural language processing (NLP) technique (e.g., a Spark-NLP package, a library for text processing), instead of conventional natural language toolkit (NLTK) packages. Step 52 can save computer processing time from more than two days over 18 million distinct public remarks in the database to one hour, and can reduce memory errors compared with conventional methods which have long processing times and significant memory errors. It should be understood that step 52 can be performed by the property data collection engine 18a.

In step 54, the system 10 adjusts a property price for each of the one or more properties based at least in part on a price index. The system 10 can perform data processing including property type assignment, state cleaning, and extreme listed price removal. For example, the system 10 can assign property types (e.g., single family, condo/townhouse, mobile home, multi-family house and other) to the one or more properties. The system 10 can clean up properties having unmatched zip codes and states. For example, some properties utilize a 3-digit zip code (corresponding to destinations outside the U.S.), but the state is incorrectly listed as Florida (FL). The system 10 can automatically detect and remove such erroneous properties.

Further, the system 10 can remove outliers of the listed prices for properties (e.g., listed prices above 99.5% and below 1%). For example, 1%-99.5% of the listed prices of properties having the single family type and condo/townhouse type can be retained for processing by the system. After filtering, a price ranged from $28,200 to $3,000,000 can be used for a single family type, and a price ranged from $29,900 to $3,845,000 can be used for a condo/townhouse type.

In some embodiments, the system 10 can further perform a zip code indicator assignment. A zip code indicator can indicate an aggregation analytics level used for each zip code within a state boundary. For example, a zip code indicator can be determined based on a property density (e.g., an average property count, or an average property count with time limit such as quarterly, monthly, yearly, seasonally, or the like). If an individual zip code corresponds to sufficient property volume (enough properties for analysis within a given zip code), the system 10 can create a price index at its 5-digit level. If a zip code corresponds to a low property volume, the system 10 can further aggregate the zip code results to make sure that each zip code is supported by enough properties for that zip code. Thus, as can be appreciated, this process allows the system to compensate for sparse data. For example, the system 10 can define four zip indicator levels for analysis including 5-digit (also referred as to Zip 5), 3-digit (also referred as to Zip 3), 2-digit (also referred as to Zip 2) and 1-digit (also referred as to Zip 1) zip code. A Zip 5 indicator level indicates that an average property count at a Zip 5 and state level is larger than a first property count threshold (e.g., a value or range indicative of a Zip 5 indicator level, such as 150 quarterly property counts). A Zip 3 indicator level indicates that an average property count at a Zip 3 and state level is larger than a second property count threshold for properties in Zip 5 area but not at the Zip 5 indicator level. The second property count threshold refers to a value or range indicative of a Zip 3 indicator level, such as 250 quarterly property counts. A Zip 2 indicator level indicates that an average property count at a Zip 2 and state level is larger than a third property count threshold for properties in Zip 5 area but not at the Zip 5 and Zip 3 indicator levels. The third property count threshold refers to a value or range indicative of a Zip 2 indicator level, such as 250 quarterly property counts. Zip 1 refers to the rest of the zip codes.

In some embodiments, the system 10 can further calculate a price index and adjust price for a particular time period (e.g., a particular quarter of a year). The system 10 can use a median price for price adjustment. The median price is less affected by extreme list prices. For example, the system 10 can calculate a quarter-to-quarter price index for different zip code indicator levels. For example, the system 10 can calculate a ratio of median prices associated with different time periods at a zip code level using a formula, such as (Median Price at Qx−Median Price at Qx−1)/Median Price Qx−1) for a price index corresponding to the quarter Qx. A quarter prior the Qx is represented as Qx−1. The system 10 can adjust the quarter-to-quarter price index. There may be some extreme price indexes, indicating not enough properties at that zip code indicator level. The system 10 can calculate a price index at a more aggregated level. For example, if a price index is larger than a first threshold (e.g., 1.6) or a price index is lower than a second threshold (e.g., 0.7), the system 10 can calculate a price index at a further aggregated level for zip codes at Zip 5, Zip 3 and Zip 2 indicator levels. The system 10 can calculate a cumulative price index indicative of a product of price indices in the past time periods and current time period. For example, with an individual quarter-quarter price index and corresponding quarter and year, the system 10 can calculate a price index from different quarters by multiplying all quarter-quarter price indices before the current quarter and year with a quarter-quarter price index for the current quarter. Further, the system 10 can determine a cumulative price index for Q3 2020 at the zip code 10005 by multiplying price indexes of Q1 2020−Q3 2020. The system 10 can adjust a list price using the cumulative price index by multiplying the list price with the cumulative price index. It should be understood that the above process is not limited to quarters, but can be applied to other time periods (e.g., daily, weekly, monthly, seasonally, yearly, or particular time periods that are contiguous or noncontiguous). It should also be understood that the step 54 can be performed by the comparable property group estimation module 20a.

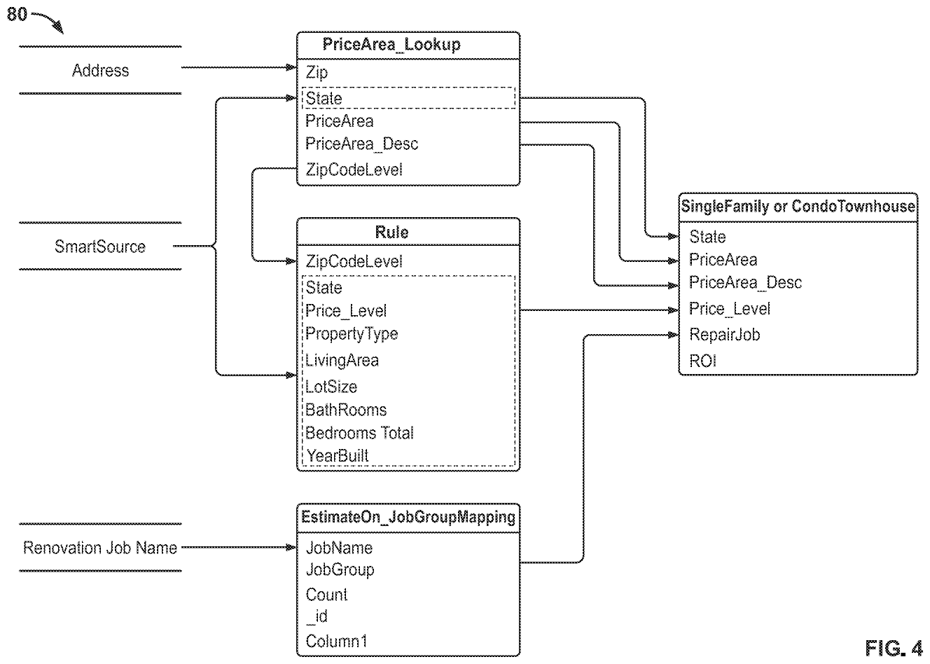

In step 56, the system 10 determines a group of properties with similar property characteristics. Examples of characteristics include a living area size, a lot size, a number of bathrooms, a number of bedrooms, a number of garage spaces, a listed price, property types, a built year, a ratio between a living area size and a lot size, and/or suitable property features. The system 10 can group properties with similar property characteristics for different locations using a decision tree. For example, the system 10 can define a zip code analytics level by utilizing zip code indicators and splitting into two zip code analytics levels, ZIP 5 and REST. In some embodiments, the system 10 can use different machine learning models for different property types. For example, the system 10 can use two machine learning models for single family and condo/townhouse based on a zip code analytics level. In some embodiments, the system 10 can use the same machine learning model for different property types. The system 10 can further define various tiers (e.g., tier I, II, III or the like) based on the adjusted prices. A tier is also referred to a comparable property group. The split can be 40%, 40%, 20% for tier I, II, III. The system 10 can define tier levels based on a zip code analytics level so that the tier is consistent with a zip code level. For example, a zip code analytics level as ZIP 5 refers to a split within 5-digit zip code. A zip code analytics level as REST indicates that if a property count at 3-digit zip code is less than a threshold (e.g., 100), the system 10 defines a tier level at a state level, otherwise defines a tier level within same 3-digit zip code. The system 10 can build decision tree machine learning models for different states, property types and zip code levels with three tiers as target and property characteristics. For example, the system 10 can build four machine learning models including a model for single family properties at a ZIP 5 level, a model for single family properties at a REST level, a model for condo/townhouse at a ZIP 5 level, and a model for a condo/townhouse at a REST level. These four machine learning models can be associated with five binned property features including a year built, a living area size, a lot size, number of bedrooms, and a number of bathrooms. The system 10 can generate a lookup table (also referred as to Rule table in FIG. 4) using the results from this step and binned property features translated from a data source. It should be understood that the step 56 can be performed by the comparable property group estimation module 20a.

In some embodiments, after testing on various clustering methods, the system 10 uses classification methods instead of unsupervised methods to accurately define property groups considering zip codes and property features, compared with the conventional methods (such as k-means clustering and Gaussian mixture model) that do not work well in high-dimensional cases considering various zip codes and property features.

In step 58, the system 10 calculates a price difference between each of the one or more properties after renovation and a similar property without renovation of the group of properties. The system 10 can perform a data processing including a data filtering and linking agent notes and property address. For example, the system 10 can analyze both single family and condo/townhouse properties and select properties built more than 5 years before being listed. The system 10 can join renovation keywords for each remark (e.g., agent notes) with a corresponding property address through PublicRemark_ID column. Some properties may have multiple agents notes. The system 10 can cover all agent notes and only count the distinct renovation projects. The system 10 can then calculate an average adjusted list price for renovated property (e.g., single family or condo/townhouse) and non-renovated property (e.g., single family or condo/townhouse) for each price area. A price area refers to an area at the same comparable property group for renovation material and labor cost. While calculating a price difference within the same property group, the system 10 can consider a number of renovation projects for a property and return allocation of properties with multiple renovation projects. For example, for properties with a single renovation project type, the system 10 can calculate a price difference and a number of renovated properties at two levels (e.g., a price area level with the renovation project type and a state level with the renovation project type). For properties with multiple renovation project types, the system 10 can define a factor as a percentage of a cost of a certain type of renovation projects among all the costs and calculate a factor for each renovation project type at a state or a price area level. The system 10 can calculate a number of renovated properties and adjust a price difference of properties with multiple renovation project types by multiplying a price difference with factors at two levels (e.g., a price area level with a renovation project type and a state level with a renovation project type). The system 10 can determine an overall price difference. For example, the system 10 can calculate a weighted average of a price difference using a number of renovated properties as a weight at two levels (e.g., a price area level with a renovation project type and a state level with a renovation project type). If there are more than a threshold number (e.g., 12 or the like) of renovated properties in a price area, a price difference of that price area can be at price area+renovation project types level. Otherwise, the results of that price area can be at state+renovation project types level. The system 10 can set any negative price differences as 0. It should be understood that the step 58 can be performed by the renovation estimation module 20b.

In step 60, the system 10 calculates a cost of the one or more renovation projects. For example, the system 10 can calculate an average cost for each renovation group based on a cost of a detail job with an average quality. The system 10 can adjust a cost for renovation groups via one or more operations of a quantity adjustment for cost of electrical by multiplying 20 (e.g., solar panels are main renovations in electrical renovation project types and an adjusted cost can be used from 1 solar panel to 20 solar panels, as research shows 20 panels are installed per property in national average.), a quantity adjustment for cost of windows by multiplying 8 (e.g., an adjusted cost can be used from 1 window to 8 windows, as research shows 8 windows are installed per property in national average), adjusted cost of framing (e.g., only use the cost from a major job, such as wall framing), adjusted cost of a foundation (e.g., only use the cost from a major job, such as slab, foundation and drainage), adjusted cost of a pool (e.g., only use the cost from a major job, such as installing or remodeling swimming pool), adjusted cost of gutters (e.g., only use the cost from a major job, such as installing or repairing metal gutters/downspout), and a quantity adjustment for the cost of kitchen by multiplying by 0.5 (e.g., a half of a full kitchen cost to reflect the combination of major and minor kitchen remodel as public data generally does not specify what level of remodel was done). It should be understood that the step 60 can be performed by the renovation estimation module 20b.

In step 62, the system 10 calculates a return on investment (ROI) associated with each of the one or more properties. An ROI is a price difference of a property between before renovation and after renovation divided by a renovation cost. The system 10 can calculate the ROI at a price area level for properties (e.g., single family and condo/townhouse, etc.) and compare with a remodel magazine. For example, the system 10 can calculated ROI with a price difference from the step 58 divided by a renovation cost from the step 60. It should be understood that the step 60 can be performed by the return on investment estimation engine 18b.

In step 64, the system 10 adjusts the ROI. For example, the system 10 can adjust ROI to avoid extreme values in the ROI for different tiers. At Tier I, the system 10 can cap at 5%-85% from non-zero ROIs. At Tier II, the system 10 can cap at 5%-85% from non-zero ROIs. At Tier III, the system 10 can cap at min-60% from non-zero ROIs. The system 10 can generate an ROI lookup table for each of the property types using the results from the steps 62 and 64. It should be understood that the step 60 can be performed by the return on investment estimation engine 18b.

By performing steps 54-64, the system 10 overcomes data sparsity challenges, because more aggregated levels are analyzed to smooth the results and to avoid spike of the ROI results caused by the data sparsity (e.g., limited geographic data associated with different renovation projects, limited properties having similar renovations in the same area, or the like).

In some embodiments, the system 10 can generate various lookup tables based on the steps 52-64. For example, the system 10 can generate a price area lookup (e.g., using the steps 54-58), a lookup table for rules (e.g., using the steps 54-58) to define tier levels for various properties (e.g., condo, single family, and other property type as described above), a lookup table for mapping between job and job grouping (e.g., using the step 52), and a lookup table for a ROI determination (e.g., using the steps 58-64). For example, as shown in FIG. 4 (which is a diagram illustrating data flows 80 among lookup tables generated by the system 10), a PriceArea_Lookup refers to a lookup table for price areas and zip code levels, a Rule refers to a lookup table for comparable property groups given property features and zip code levels, a EstimateON_JobGroupMapping refers to a lookup table for mapping between job name and job group, and an ROI lookup table for each of property types (e.g., SingleFamily refers to a lookup table for ROI of single family, and CondoTownhouse refers to a lookup table for ROI of condo/townhouse). Address refers to a property address from a user input. Renovation job name refers to a job name from a user input. SmartSource refers to a data source having property features.

The PriceArea_Lookup provides a mapping between a zip code, a price area and a zip code level. This table serves a first step to get a corresponding state, price area and zip code analytics level (column: PriceArea and ZipCodeLevel) of the property zip code. State is an abbreviation of states in US. This column links with a tier level of the property in the Rule and ROI results in the SingleFamily or CondoTownhouse. Zip is a 5-digit zip code. This information comes from the property address. PriceArea is a price area code. This column links with ROI results of single family and condo/townhouse. PriceArea_Desc is a description of a price area with a major city name or an area name. ZipCodeLevel refers to two zip code analytics levels (e.g., ZIP 5 or REST). ZipCodeLevel is used to define a tier level of the property. ZIP 5 indicates tier levels of properties in that 5-digit zip code area based on other properties in the same zip code. Those zip codes are usually with more dense population. REST indicates tier levels of properties in that 5-digit zip code area based on other properties in the same 3-digit zip code. Those zip codes tend to area with less dense population.

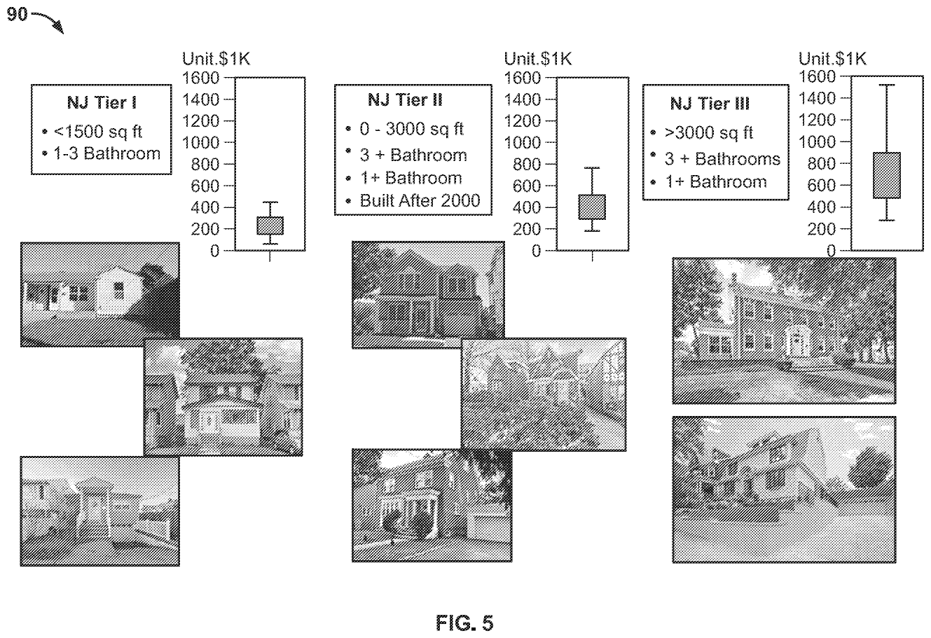

The Rule table defines a tier level of a property with a state and zip code level from the PriceArea_Lookup table and the property features from the SmartSource, such as a living area size, a lot size, a number of bathrooms, a number of bedrooms and a year of built. Each row in the Rule table indicates that one rule of a tier definition for a certain state, a property type and a zip code level. A living room size, a lot size, a number of bathrooms, a number of bedrooms and a year built from the SmartSource need a transformation to match with a corresponding column in the Rule table. This transformation also needs a property type, a state and a zip code level. For example, 3 bathrooms in a condo/townhouse in AK with ZIP 5 as zip code level can be mapped to 2+ in Bathrooms field. But in CT with ZIP 5 as a zip code level can be mapped to 2-3 in Bathrooms field. The State comes from the PriceArea_Lookup table as described above. Price_Level refers to three tiers of properties. A tier level indicates an overall property level considering a living area, a lot size, a number of bathrooms, a number of bedrooms and a year of built. This column links with the ROI results of single family and condo/townhouse. For example, FIG. 5 is a diagram illustrating single family examples 90 in different comparable property groups and in the same state. Tier I tends to have the smallest living area (e.g., <1500 square feet) compared with Tier II and Tier III. Tier II tends to have a larger living area (e.g., 0-3000 square feet) compared with Tier I, and Tier III tends to have the largest living area or newly built year compared with Tier I and Tier II.

Referring back to FIG. 4, PropertyType in the Rule table refers to either single family or condo/townhouse of the property. ZipCodeLevel refers to the two zip code analytics levels (e.g., Rest or ZIP 5) obtained from the PriceArea_Lookup. This column information comes from PriceArea_Lookup table. LivingArea refers to a living area size of the property in square feet. Blank indicates no consideration of the size of the living area. Examples in square feet can include multiple distinct values, such as 0-1000, 0-1000 or unknown, 0-1500, 0-1500 or unknown, 0-2000, 0-2000 or unknown, 0-2500, 0-2500 or unknown, 0-3000, 0-3000 or unknown, 0+, 1000-1500, 1000-1500 or unknown, 1000-2000, 1000-3000, 1000+, 1500-2000, 1500-2500, 1500-3000, 1500+, 2000-2500, 2000-3000, 2000+, 2500-3000, 2500+, 3000+, and unknown.

LotSize in the Rule table refers to a lot size with acres as unit. Blank indicates no consideration of lot size. Examples in acres can include multiple distinct values, such as 0-0.25 or unknown, 0-0.5 or unknown, 0-0.75 or unknown, 0-1 or unknown, 0-1.5 or unknown, 0-3 or unknown, 0+, 0.25+, 0.5+, 0.75+, 1+, 1.5+, 3+, and unknown.

BathRooms in the Rule table refers to a number of bathrooms. Blank indicates no consideration of the number of bathrooms. Examples include multiple distinct values, such as 0-1.5 or unknown, 0-3, 0-3 or unknown, 2-3, 2+3+ and unknown.

BedroomsTotal in the Rule table refers to a number of bedrooms. Blank indicates no consideration of the number of bedrooms. Examples include multiple distinct values, such as 0-1 or unknown, 0-2 or unknown, 0-3 or unknown, 2, 3, 4, 1+, 2+, 3+, 4+, 5+, and unknown.

YearBuilt in the Rule table refers to a year in which a property was built. Blank indicates no consideration of the year built. Examples include 850-1900 or unknown, 1850-1969, 1850-1969 or unknown, 1850-1989 or unknown, 1850-1999 or unknown, 1850-2009 or unknown, 1850+, 1901-1989, 1901-1999, 1970+, 1990-2009, 1990+, 2000-2009, 2000+, 2010+, and unknown.

EstimateON_JobGroupMapping refers to a lookup table for mapping between a job name from a user input and a job group. JobName refers to a detail job from a user input. Job_Group refers to a job group for later ROI lookups. Examples of job groups include addition job group, a job group for appliances, an asphalt job group, a basement finish job group, a bathroom remodel job group, a job group for cabinets, a cleaning job group, a concrete job group, a job group for countertops, a deck job group, a demolition job group, a door job group, a drywall job group, an electrical job group, an exterior paint job group, a fencing job group, a finish hardware job group, a finish work job group, a fireplace job group, a flooring job group, a foundation job group, a framing job group, a garage door job group, a gutter job group, an HVAC job group, an insulation job group, an interior paint job group, a kitchen remodel job group, a landscaping job group, a masonry job group, a job group for miscellaneous property assets (MISC), a mitigation job group, a patio job group, a pest control job group, a plaster job group, a plumbing job group, a pool job group, a roofing job group, a siding/soffit job group, a stucco job group, a tile job group, a wallpaper job group, a job group for window treatments, and a job group for windows.

SingleFamily table refers to ROI results lookup for a single family with a state, a price area, a comparable property group, and a job group. Columns include parameters (e.g., State, PriceArea, PriceArea) from the PriceArea_Lookup table, parameters (e.g., State, PriceArea, PriceArea) from the PriceArea_Lookup table, a Price_Level value associated with a single family type from the Rule table, and RepairJob that refers to job groups from EstimateON_JobGroupMapping table. ROI refers to a return on investment associated with a single family type in a given state, price area, comparable property group and repair job column in this table.

CondoTownhouse table refers to ROI results lookup for condo/townhouse with a state, a price area, a comparable property group, and a job group. Columns include parameters (e.g., State, PriceArea, PriceArea) from the PriceArea_Lookup table, parameters (e.g., State, PriceArea, PriceArea) from the PriceArea_Lookup table, a Price_Level value associated with a single family type from the Rule table, and RepairJob that refers to job groups from EstimateON_JobGroupMapping table. ROI refers to a return on investment associated with a single family type in a given state, price area, comparable property group and repair job column in this table.

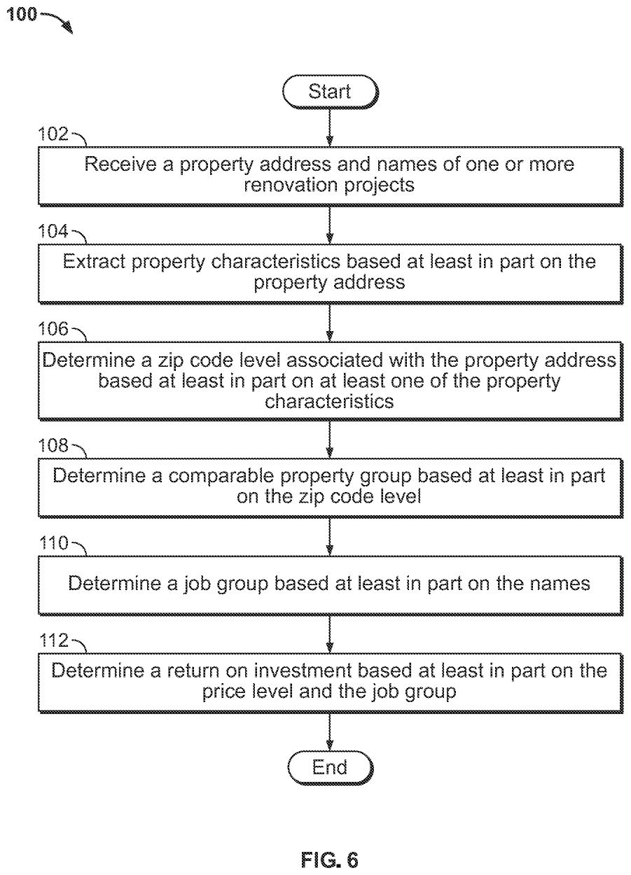

FIG. 6 is a flowchart illustrating deployment steps 100 carried out by the system 10 of the present disclosure. Beginning in step 102, the system 10 receives a property address and names of one or more renovation jobs. For example, a user can input the property address and names of one or more renovation jobs into the system 10. The renovation jobs are subgroups of renovation projects (also referred to as job groups).

In step 104, the system 10 extracts property characteristics based at least in part on the property address. For example, as shown in FIG. 4, the system 10 can receive the property address and output the property characteristics (e.g., State, PropertyType, LivingArea, LotSize, BathRooms, BedroomsTotal, YearBuilt) of a property located at the property address via a data source (e.g., a data source included in or communicated with the database 14, the data collection engine 18a, and/or the return on investment estimation engine 18b) of the system 10.

In step 106, the system 10 determines a zip code level associated with the property address based at least in part on at least one of the property characteristics. For example, as shown in FIG. 4, the system 10 can determine a zip code of the property address and retrieves the state information. The system 10 can output a zip code level using the determined zip code and/or the state information (e.g., via the PriceArea_Lookup). The system 10 can also output State, PriceArea, and PriceArea_Desc.

In step 108, the system 10 determines a comparable property group based at least in part on the zip code level. For example, as shown in FIG. 4, the system 10 can output a comparable property group using the zip code level received from the PriceArea_Lookup and State, ProeprtyType, LivingArea, LotSize, BathRooms, BedroomsTotal, YearBuilt received from the SmartSource via the Rule table.

In step 110, the system 10 determines a job group based at least in part on the names. For example, as shown in FIG. 4, the system 10 can output a job group using the names received from the user input via the EstimateON_JobGroupMapping.

In step 112, the system 10 determines a return on investment based at least in part on the comparable property group and the job group. For example, as shown in FIG. 4, if the property type is a single family, the system 10 can utilize a SingleFamily table to output an ROI based on the State, PriceArea, and PriceArea_Desc received from the PriceArea_Lookup, Price_Level received from the Rule table, and RepairJob received from the EstimateON_JobGroupMapping. If the property is a condo or townhouse type, the system 10 can utilize a Condo/Townhouse table to output the ROI.

It should be understood that the processes described in FIGS. 2 and 6 are not limited to the single family type and condo/townhouse type, but can be applied to any other suitable property type (e.g., a mobile home, a multi-family, or commercial property type). For example, if the property type is a mobile home, a multi-family, or other suitable property type, the system 10 can generate a corresponding table for a particular property type as described in FIG. 2, and utilize the corresponding table to output the ROI for the particular property type as described in FIG. 4.

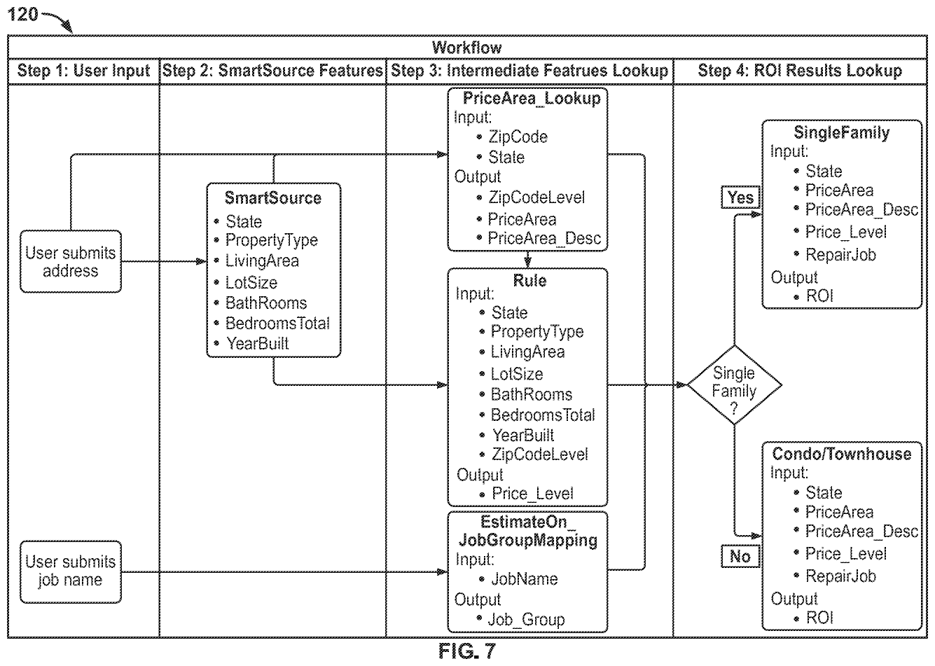

FIG. 7 is a diagram illustrating an example deployment workflow 120 carried out by the system. As shown in FIG. 7, Step 1 and Step 2 are used to obtain property characteristics as described in FIG. 6. Step 3 includes the steps 106-110 of FIG. 6. Step 4 includes the step 112 of FIG. 6. Tables in the Steps 2-4 of FIG. 7 are generated by the steps 52-64 of FIG. 2.

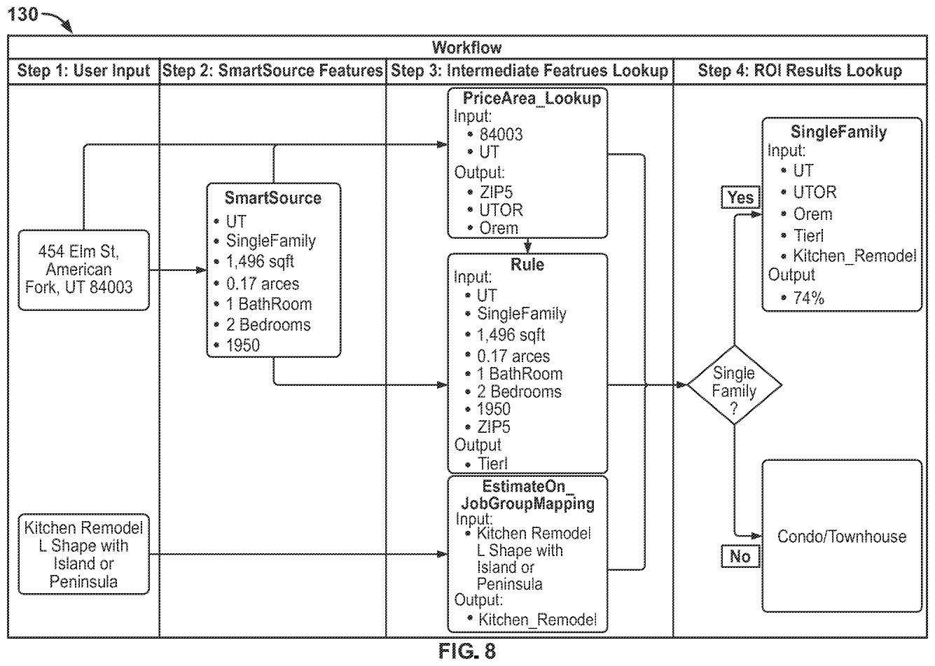

FIG. 8 is a diagram illustrating an example deployment workflow 130 carried out by the system, using an example property address and a renovation project name. For example, a user enters “454 Elm St, American Fork, Utah 84003” and “Kitchen Remodel L Shape with Island or Peninsula.” In Step 3, the system 10 outputs ZIP 5 as a zip code level, Tier I as a comparable property group and kitchen remodel as a job group. In Step 4, the system 10 outputs 74% as the ROI based at least in part on the comparable property group and job group.

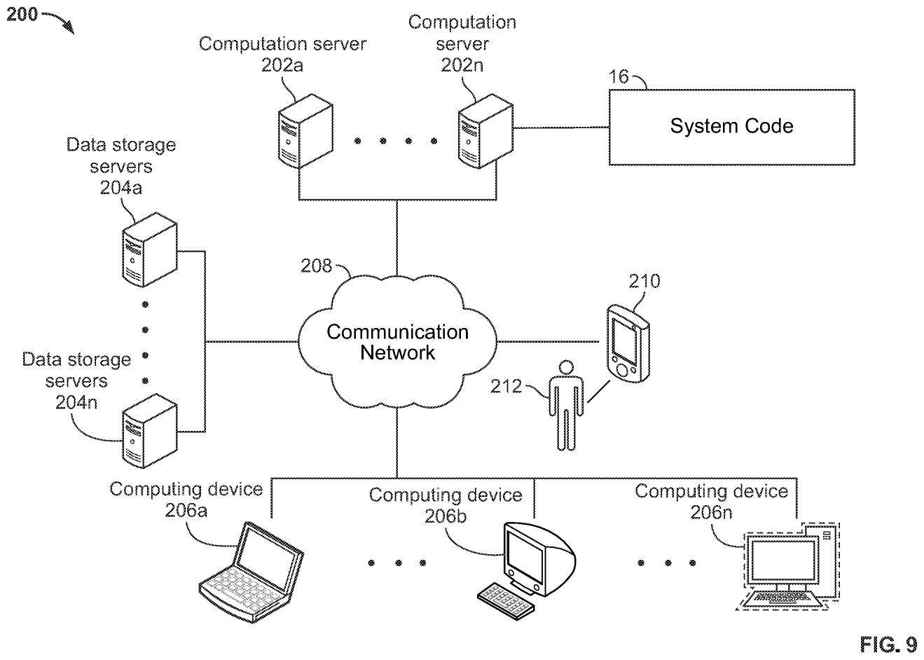

FIG. 9 a diagram illustrating computer hardware and network components on which the system 200 can be implemented. The system 200 can include a plurality of computation servers 202a-202n having at least one processor (e.g., one or more graphics processing units (GPUs), microprocessors, central processing units (CPUs), tensor processing units (TPUs), application-specific integrated circuits (ASICs), etc.) and memory for executing the computer instructions and methods described above (which can be embodied as system code 16). The system 200 can also include a plurality of data storage servers 204a-204n for storing property data (e.g., property characteristics and tables). A user device 210 can include, but it not limited to, a laptop, a smart telephone, and a tablet to access the property data, communicate with remote computing devices 206a-206n, and view analysis results. The remote computing devices 206a-206n can provide various property database (e.g., listing database, pricing database, marketplace database, or any suitable database related to properties). The remote computing devices 206a-206n can include, but are not limited to, a laptop 206a, a computer 206b, and a virtual machine 206a. The computation servers 202a-102n, the data storage servers 204a-204n, the remote computing devices 206a-206n, and the user device 210 can communicate over a communication network 208. Of course, the system 200 need not be implemented on multiple devices, and indeed, the system 200 can be implemented on a single (e.g., a personal computer, server, mobile computer, smart phone, etc.) without departing from the spirit or scope of the present disclosure.

Having thus described the system and method in detail, it is to be understood that the foregoing description is not intended to limit the spirit or scope thereof. It will be understood that the embodiments of the present disclosure described herein are merely exemplary and that a person skilled in the art can make any variations and modification without departing from the spirit and scope of the disclosure. All such variations and modifications, including those discussed above, are intended to be included within the scope of the disclosure. What is desired to be protected by Letters Patent is set forth in the following claims.

What is claimed is:

1. A machine learning system for determining return on investment information from sparse data, comprising:
a database storing information relating to a plurality of properties; and
a processor in communication with the database, the processor programmed to perform the steps of:
identifying a renovation project for at least one property to be analyzed;
adjust a property price for the at least one property based at least on part on a price index;
determine a group of properties from the database having at least one property characteristic in common with the at least one property using at least one trained machine learning model configured to be applied to public remarks associated with a plurality of properties;
calculate a price difference between the at least one property after the renovation and a similar property of the group of properties without renovation;
calculate a cost associated with the renovation project; and
calculate a return on investment for the at least one property.

2. The system of claim 1, wherein the processor is further programmed to determine the group of properties having at least one property characteristic in common with the at least one property using one or more of a single family property model or a condominium/townhouse model.

3. The system of claim 2, wherein at least one of the single family property model or the condominium/townhouse model is associated with at least one binned property feature including a year built, a living size area, a lot size, number of bedrooms, or number of bathrooms.

4. The system of claim 1, wherein the processor is further programmed to perform the steps of filtering and text processing each of the public remarks.

5. The system of claim 1, wherein the processor is further programmed to perform the steps of analyzing the plurality of properties based on at least one keyword extracted from the public remarks.

6. The system of claim 1, wherein the processor performs one or more of the steps of locating remarks within a first group of keywords, selecting embedding sentences with keywords but not words in an exclusion list, selecting properties built satisfying a built year threshold, normalizing words with lower cases, lemmatizing text of remarks, removing stop words, extracting one or more phrases, generating n-gram phrases and frequencies, analyzing n-gram results, or mapping renovation-related phrases satisfying a frequency threshold to one or more renovation project types.

7. The system of claim 1, wherein the processor processes the public remarks using natural language processing (NLP) to narrow down the remarks, thereby saving computer processing time required to process the remarks.

8. The system of claim 7, wherein the NLP reduces memory errors associated with processing of the remarks.

9. The system of claim 1, wherein the processor is further programmed to perform the step of clustering the group of properties using a data clustering technique.

10. The system of claim 1, wherein the processor is further programmed to perform the step of adjusting the return on investment.

11. The system of claim 1, wherein the processor is further programmed to generate one or more lookup tables including information relating to the return on investment.

12. The system of claim 1, wherein the processor is further programmed to receive a property address corresponding to the at least one property to be analyzed and extracts property characteristics based at least in part on the property address.

13. The system of claim 12, wherein the processor is further programmed to determine a zip code level associated with the property address and determine a comparable property group based at least in part on the zip code level.

14. The system of claim 13, wherein the processor is further programmed to determine a job group and calculate the return on investment based at least in part on the comparable property group and the job group.

15. A machine learning method for determining return on investment information from sparse data, comprising the steps of:
identifying by a processor a renovation project for at least one property to be analyzed;
adjusting by the processor a property price for the at least one property based at least on part on a price index;
determining by the processor a group of properties from a database in communication with the processor having at least one property characteristic in common with the at least one property using at least one trained machine learning model executed by the processor and configured to be applied to public remarks associated with a plurality of properties;
calculating by the processor a price difference between the at least one property after the renovation and a similar property of the group of properties without renovation;
calculating by the processor a cost associated with the renovation project; and
calculating by the processor a return on investment for the at least one property.

16. The method of claim 15, further comprising determining by the processor the group of properties having at least one property characteristic in common with the at least one property using one or more of a single family property model or a condominium/townhouse model.

17. The method of claim 16, wherein at least one of the single family property model or the condominium/townhouse model is associated with at least one binned property feature including a year built, a living size area, a lot size, number of bedrooms, or number of bathrooms.

18. The method of claim 15, further comprising filtering and text processing by the processor each of the public remarks.

19. The method of claim 15, further comprising analyzing by the processor the plurality of properties based on at least one keyword extracted from the public remarks.

20. The method of claim 15, further comprising performing by the processor one or more of locating remarks within a first group of keywords, selecting embedding sentences with keywords but not words in an exclusion list, selecting properties built satisfying a built year threshold, normalizing words with lower cases, lemmatizing text of remarks, removing stop words, extracting one or more phrases, generating n-gram phrases and frequencies, analyzing n-gram results, or mapping renovation-related phrases satisfying a frequency threshold to one or more renovation project types.

21. The method of claim 15, further comprising processing by the processor the public remarks using natural language processing (NLP) to narrow down the remarks, thereby saving computer processing time required to process the remarks.

22. The method of claim 21, wherein the NLP reduces memory errors associated with processing of the remarks.

23. The method of claim 15, further comprising clustering by the processor the group of properties using a data clustering technique.

24. The method of claim 15, further comprising adjusting by the processor the return on investment.

25. The method of claim 15, further comprising generating by the processor one or more lookup tables including information relating to the return on investment.

26. The method of claim 15, further comprising receiving at the processor a property address corresponding to the at least one property to be analyzed and extracting property characteristics based at least in part on the property address.

27. The method of claim 26, further comprising determining by the processor a zip code level associated with the property address and determining a comparable property group based at least in part on the zip code level.

28. The method of claim 27, further comprising determining by the processor a job group and calculating the return on investment based at least in part on the comparable property group and the job group.
